(19) United States
(12) Patent Application Publication
(10) Pub. No.: US 2026/0117530 A1
(43) Pub. Date: Apr. 30, 2026

(54) EDGING STRIP, IN PARTICULAR RAISED FLOOR EDGING STRIP

(71) Applicant: Fritz Egger GmbH & Co. OG

(72) Inventors: Thomas Streichardt, Warendorf (DE); Peter Florian Schwermer, Kirchhundem (DE); Jean-Pascal Lafleur, Olsberg (DE)

(21) Appl. No.: 19/469,154

(22) PCT Filed: Mar. 28, 2024
(86) PCT No.: PCT/EP2024/058507

§ 371 Date: Sep. 25, 2025

(30) Foreign Application Priority Data
Mar. 31, 2023 (EP) 23165867.5

(51) Int. Cl. E04F 15/024; B32B 5/02; B32B 7/12; B32B 27/12; B32B 27/18

(52) U.S. Cl. CPC E04F 15/02405; B32B 5/022; B32B 7/12; B32B 27/12; B32B 27/18; B32B 2250/02; B32B 2307/206; B32B 2307/3065; B32B 2307/7376; B32B 2419/04

(57) ABSTRACT

The invention relates to an edging strip, in particular a raised floor edging strip, containing a thermoplastic material, a conductivity additive and a tribology additive. The invention also relates to a method for manufacturing the edging strip, a panel with an edging strip attached to it and the use of a tribology additive to reduce creaking.

### CROSS-REFERENCE TO RELATED APPLICATIONS

The present application claims priority to PCT International Patent Application No. PCT/EP2024/058507, filed Mar. 28, 2024, and European Patent Application No. 23165867.5, filed on Mar. 31, 2023, the disclosures of which are incorporated herein by reference.

### STATEMENT RE: FEDERALLY SPONSORED RESEARCH/DEVELOPMENT

Not Applicable

### BACKGROUND

The invention relates to an edging strip, in particular to a raised floor edging strip, comprising a thermoplastic material. The invention further relates to a method for manufacturing the edging strip. The invention also relates to a raised floor element.

Raised floors are floor constructions for the interior of buildings, which form an installation space beneath their entire surface for the accommodation of all building services installations and supply and disposal lines (e.g., cables, etc.) and allow free access to such cavity at any time and at any location. Furthermore, raised floors can be used to compensate for unevenness in the subfloor, as the raised floor panels are usually mounted on height-adjustable supports.

Various raised floor elements are known from the prior art, which differ, for example, in terms of carrier material, covering, dimensions and thickness. The dimensions of a raised floor element are typically in the range of 600/600 mm to 1200/1200 mm, with thicknesses of 19 to 50 mm, depending on the load requirements and the material used. Thicknesses in the range of 30 to 38 mm are particularly common.

In addition to the requirements regarding statics and load-bearing capacity of the raised floor elements, certain fire protection classes must also be observed, as regulated, for example, in DIN EN 13501 (Fire classification of construction products and building elements).

U.S. Pat. No. 3,811,237 discloses a raised floor system in which the floor panels have a bearing layer of wood particles. However, when used as intended, potential differences between the floor panel materials and the users can lead to electrostatic charging and discharging. In U.S. Pat. No. 3,811,237, the underside is therefore covered with a sheet metal panel, while the top side is covered with a carpet material that extends beyond the face side of the panel to the underside, allowing the electrostatic charge to be transported from the top to the bottom of the panel and then dissipated into the ground via the metal supports.

Alternatively, edging strips made of an electrically conductive plastic material can be used on the floor panels to dissipate the charge. This is described, for example, in DE 20 2007 017 234 U1 and EP 1 696 038 A2. Electrical resistances of the edging strip of 10² up to 109 ohm are preferred because too high conductivity is undesirable. The edging strips are typically about 0.5 mm thick and are usually attached to the side surface of the base panel using a hot-melt adhesive. In addition to dissipating electrostatic charge, the edging strips also serve to protect the edges of the floor panels.

In the prior art, plastics, preferably thermoplastic materials, are usually used as material for the edging strip. The use of acrylonitrile-butadiene-styrene copolymer or polyvinyl chloride is widespread, but other thermoplastic polymers can also be used.

In order to obtain electrically conductive edging strips, DE 20 2012 100 911 U1 proposes, on the one hand, the use of polymeric materials that are themselves conductive due to the presence of conjugated double bonds, such as polyaniline, polypyrrole, polythiophene, and others. On the other hand, DE 20 2012 100 911 U1 proposes to make polymers that are not electrically conductive themselves conductive by adding a carbon-based or metal-based conductivity additive.

By adding the above-mentioned conductivity additives, the properties of the resulting edging bands regularly change such that they produce noises, so-called creaking or squeaking noises, when they rub against one another. In addition to the electrostatic charge that occurs when walking on raised floors, which can be reduced by conductive edges, another problem with raised floors is that creaking noises occur when walking on the raised floors, which are caused by the relative movement of the elements to one another. Various approaches have been proposed in the prior art to improve the creaking behavior of raised floor elements provided with edging strips made of an electrically conductive plastic material.

DE 20 2007 017 234 U1, for example, proposes adding graphite to the material of the edging strip. This is supposed to reduce creaking by allowing the edging strips to slide more easily against one another.

To reduce creaking noises, WO 2014/076665 A1 proposes a coating made of UV varnishes, ESH varnishes or UV water-based varnishes, which is electrically conductive and is supposed to prevent footstep and creaking noises. However, applying a varnish requires an additional method step. Also, the varnish must dry, which can give rise to further occupational safety requirements.

EP 1 696 083 A2, in turn, proposes providing edging strips with a texturing having a roughness depth of about 10 to 40 μm on the surface which are supposed to reduce the noise in raised floor panels having the edging strips lying opposite one another. However, introducing a texturing requires an additional method step, for example an embossing step. Furthermore, abrasion is a problem in such texturing.

From the above it follows that edging strips, in particular raised floor edging strips with improved creaking behavior are desirable. The object of the present invention is therefore to improve the creaking behavior of a corresponding edging strip. Ideally, the edging strip can also be manufactured more easily.

Other and further objects, characteristics and advantages of the present invention will be further explained in the following description.

### BRIEF SUMMARY

According to the invention, the present object is achieved by the edging strip according to claim 1, the method for manufacturing the edging strip according to claim 13, and the raised floor element according to claim 16.

Accordingly, the invention provides an edging strip, in particular a raised floor edging strip, containing a thermoplastic material, a conductivity additive and a tribology additive.

The invention further provides a method for manufacturing an edging strip comprising the steps of:
a) providing a composition containing a thermoplastic material, a conductivity additive and a tribology additive,
b) supplying mechanical and/or thermal energy to the composition of step a) to obtain a molding compound,
c) forming the edging strip from the molding compound.

The invention further provides a raised floor element comprising a panel and an edging strip according to the invention attached thereto.

The invention also relates to the use of a tribology additive, in particular a plastic, preferably polyketone, UHMW polyethylene or a mixture thereof, for reducing creaking in a plastic profile, in particular an edging strip.

Surprisingly, it was found that an edging strip containing a thermoplastic material, a conductivity additive and a tribology additive shows a reduction in creaking noise while having good conductivity properties. The conductivity additive and the tribology additive are different from one another.

Without wishing to be bound by any scientific theory, the addition of a tribology additive to the thermoplastic material of the edging strip seems to improve the friction properties of the edging strip when two edging strips rub against one another to such an extent that the noise development can be significantly reduced and the creaking behavior can thus be improved. At the same time, good conductivity properties can be observed.

Since two additives are added to the thermoplastic material during manufacture of the edging strip to improve the conductivity and creaking behavior of the edging strip, the edging strip according to the invention is easy to manufacture. In particular, no subsequent varnishing or embossing steps are required. In addition, there is no wear and tear during use, such as when applying a layer of varnish or introducing a texture. Therefore, the creaking behavior does not get worse even with long-term use.

Thus, the present invention discloses the possibility of providing edging strips with improved creaking behavior, which at the same time can be manufactured using a simpler method. Furthermore, the manufacturing method can be used flexibly and is compatible with many thermoplastics. In particular, thermoplastics that pose little risk in the event of a fire can also be used.

Various embodiments of the edging strip, of the method of manufacturing the same, of the raised floor element and of the use are described hereinafter, wherein the individual embodiments each apply independently of one another to the edging strip, the method of manufacturing the same, the raised floor element and the use. In addition, the individual embodiments can be combined with one another as desired.

The edging strip according to the invention contains a thermoplastic material.

In an advantageous embodiment, the thermoplastic material is a thermoplastic. Various thermoplastics can be used. The thermoplastic material, in particular the thermoplastic, is preferably selected from the group consisting of polyvinyl chloride, polypropylene, polyethylene, polystyrene, styrene-butadiene copolymers, acrylonitrile-styrene-acrylic ester copolymers, acrylonitrile-butadiene-styrene copolymers, styrene-acrylonitrile, polybutylene terephthalate, polyethylene terephthalate, polyoxymethylene, polyamide, polymethyl methacrylate, polyphenylene oxide, polyetheretherketone, polyphenylene sulfide, liquid crystal polymer, polyamideimide, polyvinylidene fluoride, polyphenylsulfone, polyaryletherketone, polyacrylonitrile, polychlorotrifluoroethylene, polyetherketone, polyimide, polyisobutene, polyphthalamide, polypyrrole, polytetrafluoroethylene, polyurethane, polyvinyl alcohol, polyvinyl acetate, polyvinylidene chloride, polylactic acid and mixtures thereof. The thermoplastic material is preferably selected from the group consisting of acrylonitrile-butadiene-styrene copolymers, polyvinyl chloride, polymethyl methacrylate, polyethylene, polylactic acid and polypropylene. More preferably, the thermoplastic material is selected from the group consisting of acrylonitrile-butadiene-styrene copolymers, polymethyl methacrylate, polyethylene, polylactic acid and polypropylene. Even more preferably, the thermoplastic material is selected from the group consisting of acrylonitrile-butadiene-styrene copolymers, polymethyl methacrylate, polylactic acid and polypropylene. The thermoplastic material polypropylene is particularly preferred.

The edging strip according to the invention can contain the thermoplastic material in different amounts. The edging strip preferably contains the thermoplastic material in an amount of 30 to 90 wt. %, preferably 30 to 80 wt. %, particularly preferably 40 to 80 wt. %, 30 to 75 wt. %, preferably 40 to 75 wt. %, based on the total weight of the edging strip.

The edging strip according to the invention contains a conductivity additive. This allows the conductivity of the edging strip to be adjusted. Various conductivity additives can be used. The conductivity additive is preferably carbon-based or metal-based. In an advantageous embodiment, the conductivity additive is selected from the group consisting of carbon black, graphite, carbon nanotubes, carbon fibers, metal particles, metal-coated glass fibers and mixtures thereof. The conductivity additive carbon black is particularly preferred. The conductivity of the edging strip can be easily adjusted using the conductivity additives mentioned above.

The edging strip according to the invention can contain the conductivity additive in different amounts. Advantageously, the edging strip contains the conductivity additive in an amount of 1 to 50 wt. %, preferably 10 to 40 wt. %, particularly preferably 15 to 30 wt. %, based on the total weight of the edging strip.

According to the invention, the creaking behavior of the raised floor element is improved by adding a tribology additive to the material of the edging strip. In particular, the edging strip contains the tribology additive in addition to the thermoplastic material. The tribology additive can in particular have good friction properties. In a preferred embodiment, the tribology additive is a plastic. Further preferably, the plastic is polytetrafluoroethylene, polyoxymethylene, polyketone, polyethylene or a mixture thereof. UHMW polyethylene is preferably used as polyethylene. The plastic polyketone or UHMW polyethylene is particularly preferred.

UHMW polyethylene stands for ultra-high molecular weight polyethylene. UHMW polyethylene preferably has a molecular weight, in particular a weight-average molecular weight, of 1,000,000 g/mol to 10,000,000 g/mol. Methods for determining the molecular weight are known to a person skilled in the art. The molecular weight can be determined by solvent viscometry (capillary) according to ISO 1628-3:2010 with calculation of the molar mass according to Mark-Houwink.

Polyketone is particularly characterized by its good processability and its high effectiveness as a tribology additive.

The polyketone preferably has a melting temperature of 190° C. to 250° C., further preferably of 200° C. to 240° C., particularly preferably of 210° C. to 230° C., measured according to ISO 11357.

Furthermore, the polyketone preferably has a melt flow index of 40 g/10 min to 80 g/10 min, further preferably of 50 g/10 min to 70 g/10 min, measured according to ASTM D1238 at a temperature of 240° C. with a weight of 2.16 kg.

Polyketone can be obtained in particular by copolymerization of one or more olefins, such as ethylene or propylene, with carbon monoxide.

In view of the previous attempts in the prior art to improve the creaking behavior of edging strips, for example by adding graphite or by using externally applied varnishes, it is surprising that a plastic, such as polyethylene or polyketone, is suitable for improving the creaking behavior. Especially compared to varnishes, the addition of a plastic to the edging strip simplifies manufacture, as no additional work step is required on the shaped edge. With regard to graphite, plastics have the advantage that they do not cause strong coloration.

The edging strip according to the invention can contain the tribology additive in different amounts. Advantageously, the edging strip contains the tribology additive in an amount of 5 to 25 wt. %, preferably 10 to 20 wt. %, based on the total weight of the edging strip. Depending on the tribology additive used and the thermoplastic material of the edging strip, the amount of tribology additive may also be limited. For example, the amount may be limited to a maximum of 25 wt. % or a maximum of 20 wt. % due to limited miscibility.

The electrical conductivity of the edging strip is an important property because it serves to safely dissipate the electrostatic charge that arises during use. This property is particularly important in rooms with electrical devices. In an advantageous embodiment, the material of the edging strip therefore has an electrical conductivity measured in the passage of 5*10⁻¹⁰ up to 5*10⁻⁶ S.

Furthermore, it is advantageous that the edging strip according to the invention has good surface resistance. According to one embodiment, the edging strip has a surface resistance of 10⁶ ohm or less, preferably 5*10⁵ ohm or less, further preferably 10⁵ ohm or less, particularly preferably 5*10⁴ ohm or less, measured according to IEC 61340-4-1, in particular IEC 61340-4-1, edition 2016-04. Preferably, the edging strip has a surface resistance of 10² ohm or more. Due to the aforementioned surface resistances, the edging strip can effectively dissipate electrostatic charge.

It is furthermore advantageous if the edging strip has good contact resistance. Accordingly, in a further advantageous embodiment, the edging strip according to the invention has a contact resistance of 10⁶ ohm or less, preferably 5*10⁵ ohm or less, further preferably 10⁵ ohm or less, particularly preferably 5*10⁴ ohm or less, measured according to IEC 61340-4-1, in particular IEC 61340-4-1, edition 2016-04. Preferably, the edging strip has a contact resistance of 10² ohm or more.

Fire behavior is also an important property when using edging strips in raised floor systems. In an advantageous embodiment, the edging strip according to the invention has a fire behavior of at least class E according to the DIN EN 13501 standard, in particular DIN EN 13501-1:2019-05.

The present invention provides an edging strip with improved creaking behavior. In particular, the edging strip according to the invention shows reduced creaking.

The creaking behavior of the edging strip can be examined using the creaking test method described below. The test specimen is a 41 mm thick particle board that is chamfered (4°) on the face side and provided with the edge to be tested on all four sides. Two of these test specimens are produced. The two test specimens are placed on a rectangular steel frame, which is twice the size of a test specimen and has a vertical support for supporting the panels at each corner and in the middle of the long side, so that the panels touch one another on one side surface. The steel frame has a horizontal stop on one short side; from the opposite side, the panels are fixed using a pneumatically movable stop and the clamping force of the panels is adjusted.

The creaking behavior is examined over a period of three days. On the first day, the panels are clamped horizontally with a force of 300 N. The two panels are then periodically loaded in the vertical direction by means of pneumatic cylinders from above, near the side (each 5 cm away from the side) where the panels touch. The panels are loaded 900 times per hour with a force of 1250 N (which corresponds to 900 cycles per hour). On the second day, the horizontal clamping force is increased to 600 N and on the third day to 800 N, wherein the clamping force is increased while the test is ongoing. A total of at least 54,000 load cycles are carried out per edge or panel pair. Scraping or creaking noises that occur during more than 100 consecutive cycles are documented with the test date and time (quiet-average-distinct). If no noise occurs, this is also documented every two hours. Temperature and humidity are also documented.

The edging strip according to the invention can have different sizes. In one embodiment, the edging strip has a thickness of 0.2 to 5 mm, preferably 0.2 to 2 mm, further preferably 0.2 to 1 mm. According to a further embodiment, the edging strip has a width of 10 to 120 mm, preferably 25 to 60 mm.

The edging strip must be attached to the floor panel in order to be used in a raised floor system. Preferably, the edging strip is attached to the base panel with a hot-melt adhesive. A hot-melt adhesive is preferably applied to the edging strip while attaching the edging strip to the base panel. According to one embodiment, the edging strip comprises an adhesion promoter and/or a hot-melt adhesive, in particular an adhesion promoter layer. According to one embodiment, the edging strip comprises an adhesion promoter, in particular an adhesion promoter layer. This can improve adhesion between the edging strip and the hot-melt adhesive.

Various hot-melt adhesives can be used. Preferably, the hot-melt adhesive is a hot-melt adhesive based on a polyamide, a polyethylene, an amorphous polyalphaolefin, a polyester elastomer, a thermoplastic polyurethane (TPU), a reactive polyurethane, an ethylene-vinyl acetate copolymer, or a copolyamide elastomer.

Further measures can be taken to further reduce the frictional effect. In an advantageous embodiment of the edging strip according to the invention, a nonwoven material is laminated onto the edging strip. The nonwoven material is preferably laminated to the side opposite the side to be attached to the panel. The deformability of the nonwoven material can further reduce the frictional effect.

As described at the outset, a further aspect of the present invention is a method for manufacturing the edging strip according to the invention, comprising providing a composition and supplying mechanical and/or thermal energy to the composition in order to obtain a molding compound from which the edging strip is formed.

In one embodiment, the composition is provided as a masterbatch. However, it is also conceivable for the composition to be provided by mixing the individual components.

The supply of mechanical and/or thermal energy to the composition can be carried out in various ways. For example, the composition may be melted, mixed with a mixer and/or treated in an extruder. According to a preferred embodiment, the method comprises an extrusion step. For example, the edging strip can be manufactured by extrusion and using a downstream calender. This increases quality and cost-effectiveness during manufacture of the edging strip.

As a further aspect, the invention comprises the use of a tribology additive, in particular a plastic, for reducing creaking in a plastic profile, in particular an edging strip.

According to one embodiment of the use according to the invention, the plastic is polyketone, polyethylene or a mixture thereof. UHMW polyethylene is preferably used as polyethylene.

What has been said above regarding the edging strip and its components applies accordingly to the use according to the invention.

Finally, as a further aspect, the invention relates to a raised floor element comprising a panel and an edging strip according to the invention fastened thereto.

The raised floor element can further comprise a bearing panel, a support, a head panel and/or a base panel. The raised floor element preferably comprises all of the aforementioned components.

### BRIEF DESCRIPTION OF THE DRAWINGS

The invention is explained in more detail below by the exemplary drawings, which are in no way limiting. Like reference numerals refer to like elements. In the drawings:

FIG. 1 shows a side view of a raised floor, wherein the panels are edged with the edging strip according to the invention, and

FIG. 2 shows a plan view of a section of a raised floor, wherein the panels are edged with the edging strip according to the invention.

### DETAILED DESCRIPTION

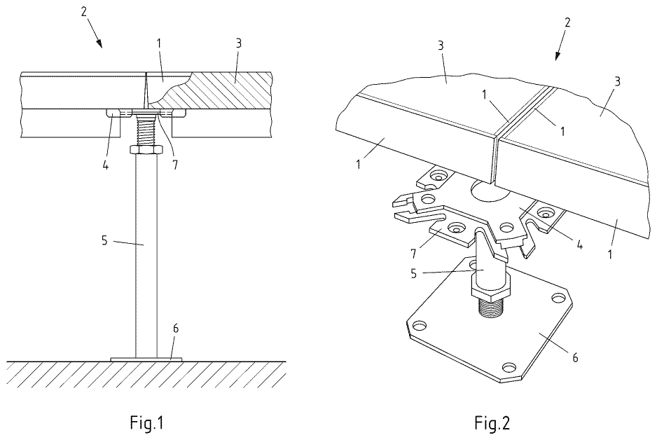

FIG. 1 shows a side view of part of a raised floor comprising raised floor elements 2. The raised floor element 2 comprises a particle board 3 which is chamfered at 4° and has an edging strip 1 according to the invention on all four narrow sides. The edging strip 1 has been attached to the particle board 3 with a hot-melt adhesive and has an adhesion promoter on the side facing the particle board to improve the adhesion of the hot-melt adhesive to the edging strip 1. The edging strip 1 is made of polypropylene and contains about 24 wt. % carbon black and about 20 wt. % polyketone.

The edged panels rest on a bearing panel 4, which in turn is connected to a head panel 7. The head panel 7 is connected to a support 5 which is attached to a base panel 6. As can be seen in FIG. 1, the edged panels are positioned such that a triangular gap is formed due to the chamfers on the panels, which closes towards the top. This arrangement of the panels is also used for the creaking test method.

FIG. 2 shows another view of the part of the raised floor comprising raised floor elements 2 from FIG. 1. The particle boards 3 edged with the edging strip 1 according to the invention rest on the bearing panel 4, which rests on the head panel 7, which is connected to the base panel 6 via the support 5.

### Examples

Mixtures of a polypropylene compound (PP-Cpd) filled with 40% carbon black and pure polypropylene (PP) according to Table 1 were prepared. UHMW polyethylene (UHMW-PE) and polyketone (PK) were added to some of the edging strips.

TABLE 1
Mixtures of polypropylene compound and polypropylene
(specified components in wt. %)

| No. | 1^{a} | 2^{a} | 3 | 4 | 5 | 6 | 7 |
|---|---|---|---|---|---|---|---|
| PP-Cpd | 0 | 60 | 60 | 60 | 60 | 60 | 60 |
| PP | 100 | 40 | 35 | 25 | 35 | 25 | 20 |
| UHMW-PE | 0 | 0 | 5 | 15 | 0 | 0 | 0 |
| PK | 0 | 0 | 0 | 0 | 5 | 15 | 20 |

Explanations regarding Table 1:
^{a}Comparative Example.

The mixtures were then fed into an extruder and edging strips 1 to 7 were extruded therefrom.

The surface resistance of the edging strips 1 to 7 obtained in this way was measured according to IEC 61340-4-1, edition 2016-4.

The edging strips 1 to 7 were then mounted to 41 mm thick particle boards, chamfered (4°) on the face side, for raised floor elements using hot-melt adhesive. All edging strips adhered well to the panels.

The creaking behavior of said edged raised floor elements was then determined using the creaking test method described above, wherein two of the particle boards with edging strips 1 to 7 (edged on all four sides) were used as test specimens. The results are shown in Table 2.

TABLE 2
Surface resistance and creaking behavior of edging strips 1 to 7

| No. | 1^{a} | 2^{a} | 3 | 4 | 5 | 6 | 7 |
|---|---|---|---|---|---|---|---|
| OW^{b} | >10³ | 10 | 13 | 16 | 11 | 13 | 14 |
| KV^{c} | ++ | − | 0 | + | 0 | + | ++ |

Explanations regarding Table 2:
^{a}Comparative Example;
^{b}OW: Surface resistance in kiloohm;
^{c}KV: Creaking behavior ++: no audible creaking, +: quiet, only temporary creaking, 0: quiet creaking, − loud creaking.

As can be seen in Table 2, it was possible to significantly reduce the surface resistance by using the carbon-black-filled polypropylene compound (cf. edging strip 1 compared to edging strips 2 to 7). Accordingly, electrical conductivity was also increased. However, it was also found that edging strip 2, which only contained the carbon-containing component carbon black, creaked. However, the creaking could be reduced by adding UHMW polyethylene or polyketone (cf. edging strip 2 compared to edging strips 3-7).

1. An edging strip, in particular a raised floor edging strip, containing a thermoplastic material, a conductivity additive and a tribology additive, wherein the tribology additive is a plastic.

2. The edging strip according to claim 1, wherein the thermoplastic material is a thermoplastic.

3. The edging strip according to claim 1, wherein the conductivity additive is carbon-based or metal-based.

4. The edging strip according to claim 1, wherein the tribology additive polytetrafluoroethylene, polyoxymethylene, polyketone, polyethylene, in particular UHMW polyethylene, or a mixture thereof.

5. The edging strip according to claim 1, wherein the material of the edging strip has an electrical conductivity measured in the passage of 5*10⁻¹⁰ up to 5*10⁻⁶.

6. The edging strip according to claim 1, wherein the edging strip has a surface resistance of 10⁶ ohm or less.

7. The edging strip according to claim 1, wherein the edging strip has a contact resistance of 10⁶ ohm or less.

8. The edging strip according to claim 1, wherein the edging strip has a fire behavior of at least class E according to the DIN EN 13501 standard.

9. The edging strip according to claim 1, wherein the edging strip has a thickness of 0.2 to 5 mm, a width of 10 to 120 mm, or both.

10. The edging strip according to claim 1, wherein the edging strip comprises an adhesion promoter, a hot-melt adhesive, or both.

11. The edging strip according to claim 10, wherein the hot-melt adhesive is a hot-melt adhesive based on a polyamide, a polyethylene, an amorphous polyalphaolefin, a polyester elastomer, a thermoplastic polyurethane, a reactive polyurethane, an ethylene-vinyl acetate copolymer, or a copolyamide elastomer.

12. The edging strip according to claim 1, wherein a nonwoven material is laminated onto the edging strip.

13. A method for manufacturing an edging strip according to claim 1, comprising the steps of:
a) providing a composition containing a thermoplastic material, a conductivity additive and a tribology additive,
b) supplying mechanical energy, thermal energy, or both to the composition of step a) to obtain a molding compound, and
c) forming the edging strip from the molding compound.

14. The method according to claim 13, wherein the method comprises an extrusion step.

15. (canceled)

16. A raised floor element comprising a panel and an edging strip attached thereto according to claim 1.
